(19) United States
(12) Patent Application Publication
(10) Pub. No.: US 2007/0216244 A1
(43) Pub. Date: Sep. 20, 2007

(54) Motor with rotor supporting windings

(76) Inventor: Jonathan Sidney Edelson, Portland, OR (US)

Correspondence Address: Borealis Technical Limited, 23545 NW Skyline blvd, North Plains, OR, 97133-9205, US

(21) Appl. No.: 11/587,348

(22) PCT Filed: Apr. 22, 2005
(86) PCT No.: PCT/US05/13748

§ 371 Date: Oct. 24, 2006

Related U.S. Application Data
(60) Provisional application No. 60/565,802, filed on Apr. 26, 2004.

(51) Int. Cl. H02K 11/00; H02K 7/09; H02K 3/00

(52) U.S. Cl. 310/90.5; 310/179; 310/68 B; 318/801; 318/727

(57) ABSTRACT

The present invention relates to the use of stator windings of an induction machine to provide both rotation of the rotor and active rotor positioning within the stator frame by modification of the magnetizing current component in the D-Q plane of the rotor applied transformed to the AC waveform current of the stator windings according to an X-Y direction describing a rotor repositioning requirement.

### TECHNICAL FIELD

The present invention relates to electrical rotating machinery and rotor bearings.

### BACKGROUND ART

During motor operation, strong magnetic forces tend to pull the rotor against the stator. In general, these forces are quite well balanced across the circumference of the air gap, and suitable shaft bearings maintain the rotor in proper position. However, small misalignments in rotor position can cause an imbalance of forces on the bearings, which will cause increased bearing wear, and may lead to machine failure.

Magnetic bearings are well known to the field of rotating machinery. Their operation may be seen in FIGS. 1a and 1b (prior art). Magnetic bearings may either be passive or active bearings. Active magnetic bearings utilize position sensors which detect the location of the rotating member, and the displacement between the actual location of the rotating member and the desired location is determined. Magnetic coils are energized accordingly to pull the rotating member in the direction of the energized coils to the desired location.

U.S. Pat. No. 6,559,567 discloses an electromagnetic rotary drive, designed as bearingless motor, which comprises a magnetically journalled rotor and a stator which comprises a drive winding for producing a magnetic rotary drive field which produces a torque on the rotor, and a control winding for producing a magnetic rotary control field by means of which the position of the rotor with respect to the stator can be regulated, with the stator having exactly six stator teeth. These two windings, which, in one embodiment are combined into a single winding, must each generate a magnetic field of a different number of poles from one another.

In a three-phase induction motor, the currents are controlled in each of the phase windings in such a way as to establish a magnetic field in the rotor and cause the rotor to align with the field flux. Then, by properly controlling the currents in the stator field, a vector is produced that leads to the shared magnetic field of the stator and rotor, which causes the rotor, and ultimately the shaft, to move. In a three-phase motor, the stator is an electromagnet made with a winding for each phase on a soft iron casting. In each winding, current may flow in a forward (positive) or reverse (negative) direction; this results in six unique steps or pole alignments. The amount of current that flows is controlled by either pulse width modulation (PWM) or analog means. The resolution of control depends on the resolution of the positioning feedback device, the current feedback, and the update rate.

At a fixed point in time, two currents are involved in the motion of the rotor. One current, i_{d}, is associated solely with the stator flux. This is the current that induces a magnetic field in the rotor of an induction motor and, held constant, causes the rotor to align with it. Use of that current alone gives a stepper motor, as its motion can be controlled by indexing the stator flux in a circular fashion. This produces very little torque, however. The only torque it does produce results from the motion of the flux to the next indexed step. The second current is 90 degrees out of phase with the first and is called the quadrature current, or i_{q}. This current produces a flux that either leads or trails the stator flux. If it trails the stator motion, the motor is a generator. If it leads, there is torque, and thus, a motor. The size of i_{q} determines the amount of torque.

To control or correct the operation of a motors, it is necessary to know the currents and position of the rotor. Generally the Clarke transform is used to change the reference of the three-phase currents, iₐ(t), ib(t), and ic(t) to currents in the two-phase orthogonal stator axis: iₐ and i_{b}. This conversion is illustrated in FIG. 1c. Now, referring to the star-connected motor in FIG. 1d, gives:
iₐ(t)+i_{b}(t)+i_{c}(t)=0
Vₐ(t)+V_{b}(t)+V_{c}(t)=0
φₐ(t)+φ_{b}(t)+φ(t)=0
which denote currents, voltages, and flux linkages. The final relationship maintains the balance of currents, voltages, or flux linkages as explained by Kirchoff's Law, that is, their sum will be zero. Anytime there is a current, voltage, or flux in one phase there must be corresponding currents, voltages or fluxes in the other two to balance it. Both the forward and reverse Park and Clarke transforms may be applied to currents, voltages, or linkages in exactly the same way. Currents in the phase windings are used to compute new voltages for the drive waveforms (eg PWM). With this in mind, the following relationship exists between a homopolar and three-phase system:

$$y = \frac{2 π}{3} \\ [ \begin{matrix}{i}_{α} ( t ) \\ {i}_{β} ( t )\end{matrix} ] = \frac{2}{3} [ \begin{matrix}1 & cos ( γ ) & cos ( 2 γ ) \\ 0 & sin ( γ ) & sin ( 2 γ )\end{matrix} ] [ \begin{matrix}{i}_{a} ( t ) \\ {i}_{b} ( t ) \\ {i}_{c} ( t )\end{matrix} ]$$

U.S. Pat. No. 6,054,837 discloses polyphase induction machine operated by an inverter drive system. The machine is constructed with concentrated full span windings. Twelve or more phases are used to sufficiently cover the airgap region, in contrast to the conventional three phases using distributed and chorded windings. Substantial efficiency and starting torque benefits are thereby obtained

U.S. Pat. No. 6,570,361 discloses an electrical rotating apparatus comprising an inverter system that outputs more than three phases. The apparatus further includes a stator comprising a plurality of slots and full span concentrated windings, with the windings being electrically coupled to the inverter system, and a rotor electromagnetically coupled to a magnetic field generated by the stator. A signal generator generates a drive waveform signal, that has a fundamental frequency, and the drive waveform signal drives the inverter system. The drive waveform signal has a pulsing frequency and is in fixed phase relation to the fundamental frequency.

U.S. Pat. No. 6,351,095 discloses an electrical rotating machine comprising an inverter drive system wherein alternating current comprising more than three phases is produced from the inverter drive system. The machine further includes a stator comprising a plurality of slots and windings, wherein the windings are electrically coupled to the inverter drive system and a winding chording factor of the stator is approximately 1. Further, a winding distribution factor of the stator could also be approximately 1. A rotor in the machine is electromagnetically coupled to a rotating magnetic field generated by the windings and the rotating magnetic field has a flux density level that exhibits saturation effects.

U.S. Pat. No. 6,348,775 discloses a polyphase induction motor operated by an inverter drive system comprising a logic level controller. A number, preferably twelve or more, of independently driven phases causes harmonic fields, up to a number equal to the number of phases, to oscillate in synchrony with the fundamental oscillating field. A pulse-width modulation (“PWM”) carrier is used by the logic level controller to synthesize a desired drive alternating current, in which the pulsing distortion produced by the pulse width modulation produces a synchronous oscillating field in the driven polyphase induction motor.

In these high phase order motor, a plurality of stator windings are individually controlled by independent inverter half bridges. Normally in a multiple pole motor, there will be several windings located in different portions of the stator, each driven by a separate inverter half bridge, but operated at the same electrical phase angle. During balanced operation, these separate windings will be operated under conditions of the same voltage, frequency, and phase. In a large machine, numerous independently driven windings may be used. Provision is made to ensure that drive balance is achieved at all times by selecting driven winding ends in sets which have odd numbers and which are symmetrically distributed. Most commonly, in the case of motors wound with a multiple of three phases, driven winding ends are selected in sets of three, and in each set the windings are driven 120 electrical degrees apart.

Thus, for example, an eighteen phase machine having 18 windings in 36 slots may have winding ends at: 0°, 10°, 20°, 30°, 40°, 50°, 120°, 130°, 140°, 150°, 160°, 170°, 240°, 250°, 260°, 270°, 280°, and 290° be driven. As described above, this will result in a balanced drive. A better connection may include a winding connection which is not only balanced for the primary, or fundamental waveform, but which is also maximally balanced for harmonic waveforms. In the above example, the winding is not balanced for the third harmonic, and will thus exhibit uneven flow of the third harmonic. The general rule for selection of winding connections is that the winding connections are preferably maximally distributed. Thus, for this example with an 18 phase machine, with star connection, a possible connection might be: 0°, 10°, 40°, 50°, 80°, 90°, 120°, 130°, 160°, 170°, 200°, 210°, 240°, 250°, 280°, 290°, 320° and 330°. This winding is perfectly balanced for the fundamental, third, fifth, and seventh harmonic, and exhibits unbalanced drive at the ninth harmonic.

### DISCLOSURE OF INVENTION

From the foregoing, it may be appreciated that a need has arisen for an electric motor in which deviations from a balanced operation, which places unwanted stress on the bearings, are corrected. Deviations from balanced operation may arise, for example, as a result of gravity, or as a result of the effect of the load on the rotor rotation.

The invention is directed to a motor having an actively alignable rotor comprising a rotor and a stator. The stator comprises a plurality of conductors supplied with electrical current for rotating said rotor, and some or all of the conductors, termed “a conductor set”, span less than 180 rotational degrees on the stator—these are the windings through which rotor alignment is applied. The motor also includes a rotor position sensor for determining rotor misalignment over time, and a control unit for controlling the current supplied to said stator conductors in the usual way. Specific to the invention is a processing means, connected to an output of said rotor position sensor, for calculating a magnetizing torque correction factor for the individual windings of the conductor set to substantially realign the rotor.

The motor should preferably be an induction motor, and the control unit should involve field oriented control or any other open or closed loop control system used in the art to control rotation.

The motor should have at least some of the windings spanning less than 180 degrees, eg a 2 pole short span motor, or a motor with four or more poles. Each phase of the “conductor set” should have N/2 individually driven windings, where N equals the number of stator poles. These windings are wound between adjacent poles.

In one embodiment, a control unit determines a phase current for each phase to cause a required rotor rotation, and then the processor distributes this unevenly amongst the windings of each phase of the “conductor set” amongst the individually driven windings of that phase, according to the effect of the position of each winding on the rotor, to realign the rotor.

In another embodiment, the processor allows a certain amount of imbalance and varies the magnetizing current for a winding of a phase without balancing it out by varying the magnetizing current in the other windings of the phase to an equal and opposite degree.

### BRIEF DESCRIPTION OF DRAWINGS

For a more complete explanation of the present invention and the technical advantages thereof, reference is now made to the following description and the accompanying drawings, in which:

FIG. 1a (prior art) is a schematic of magnetic bearings;

FIG. 1b (prior art) shows how the magnetic flux caused by the stator can influence rotor position;

FIG. 1c (prior art) shows a diagrammatic representation of field oriented control;

FIG. 1d (prior art) is a diagrammatic representation of field oriented control;

FIG. 2 show a schematic representation of a method of controlling the rotor according to the present invention;

FIG. 3 show a sensor arrangement according to a method of the present invention;

FIG. 4 represents winding connections according to one embodiment of the present invention;

FIG. 5 is a diagram showing the directions in which control may be applied to rotor position;

FIG. 6 represents an embodiment of the present invention, utilizing single conductors in place of stator windings;

FIG. 7 represents one embodiment of a high phase order machine being used according to the method of the present invention;

FIG. 9 represents one embodiment of a high phase order machine being used according to the method of the present invention.

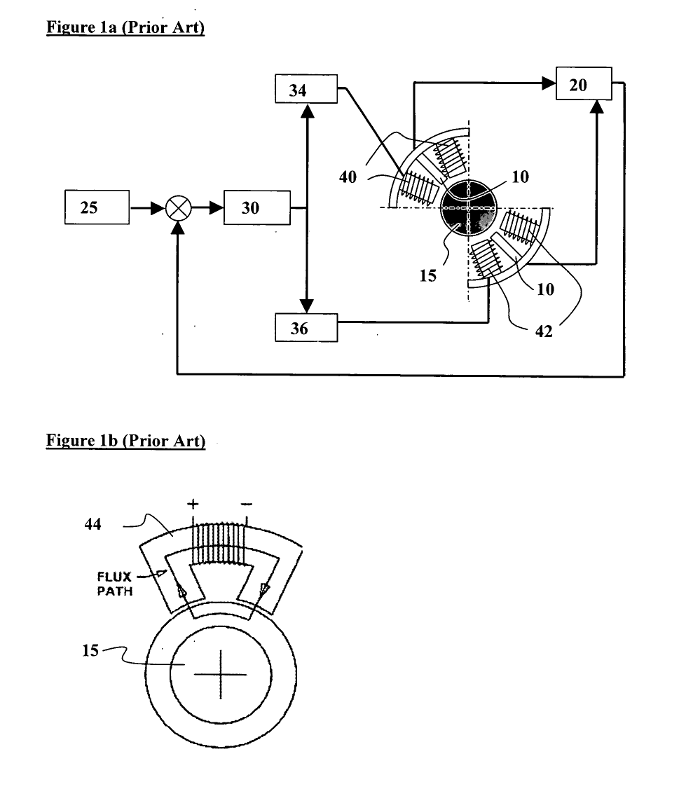

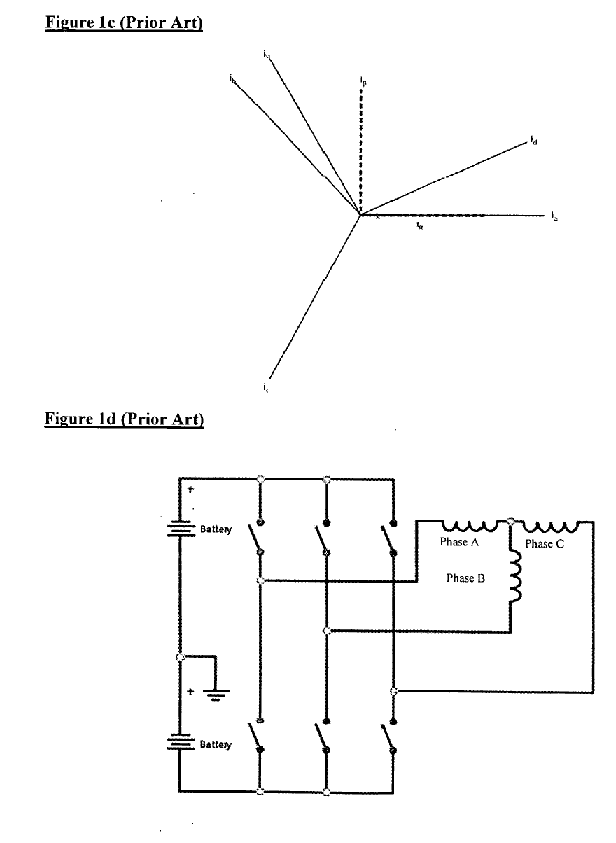

### BEST MODE FOR CARRYING OUT THE INVENTION

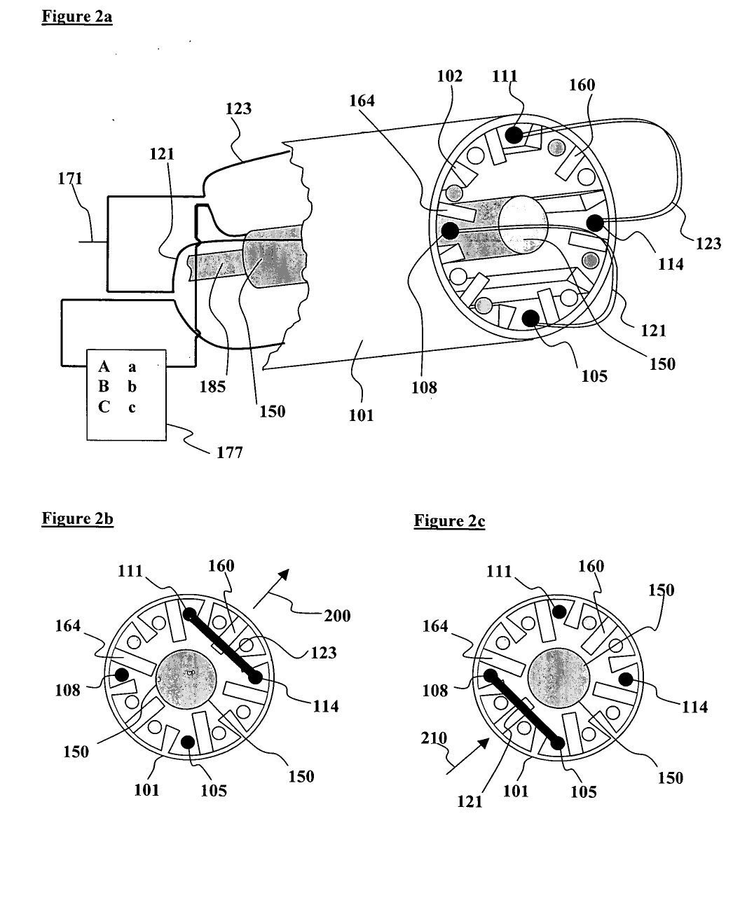

Embodiments of the present invention and their technical advantages may be better understood by referring to FIGS. 2-9.

Referring now to FIG. 2a, which shows a diagrammatic view of a three phase four pole motor, rotor 150 is connected to shaft 185, stator 101 has teeth 102 and slots 105-116 (of which only 105, 108, 111 & 114 are shown for clarity), and inverter 177 has outputs A, a, B, b, C, and c. Stator slots 105, 108, 111, and 114, in solid shading, hold windings of substantially the same phase. Stator slots 105 and 108 contain winding 121, and stator slots 111 and 114 similarly contain winding 123. Winding 121 is connected to inverter output A whilst winding 123 is connected to inverter output a. Similarly, although to preserve clarity not shown, stator slots 106, 109, 112 and 115 also contain windings driven with AC drive waveform of substantially the same phase as one another. Thus stator slots 106 and 109 hold a stator winding connected to inverter output B, and stator slots 112 and 115 hold a stator winding connected to inverter output b. Stator slots 107, 110, 113 and 116 are also driven with AC drive waveform of substantially the same phase as one another; 107 and 110 hold one stator winding, connected to inverter output C, while stator slots 113 and 116 hold a different stator winding, connected to inverter output c. The other terminal of each of the stator windings is connected to a zero voltage point, 171, thereby providing a star connection. Each winding is driven by a different inverter half bridge (not shown) so that there are six inverter half-bridges driving the three phases. The invention is not limited to inverter half-bridges, and these may be substituted for six full-bridges, as required. Inverter output A and inverter output a represent the same phase in different poles, and would usually have identical AC waveform current. According to the method of the present invention, inverter output A and inverter output a are synthesized independently. Winding 123 for example, is wound between stator slots 111 and 114 and connected to inverter output a, whilst winding 121 is wound between stator slots 105 and 108 and are connected to inverter output A. Although the stator slots may be spaced evenly around the stator, the two windings may have slightly different phase angles from one another, due to the implementation of the present invention.

Rotor 150 is, in operation, located substantially co-axially with the stator, along a stator axis Z (not shown). Radial sensors 160-165, of which only 164 and 160 are labeled in FIG. 2a, measure the radial alignment of the rotor, and output a signal indicative of the offset of the rotor from an axially aligned position within the stator. Six radial sensors are shown, although this number may be increased or decreased due to weight or accuracy or other considerations. Radial sensors 160-165 each only measure displacement in one direction and the result of the displacement is sent to a processor 180 (connections and processor not shown) and is applied in an analog fashion to only one winding, that is, the winding filling two stator slots that the radial sensor is located equidistantly between. This offset signal is connected to a look-up table of values of necessary magnetizing current to be added or subtracted from the AC drive waveform current fed to the winding that is centered around that sensor on a cross-section of the stator face. As mentioned, the rotor alignment could alternatively be applied by the winding filling the other two stator slots of that phase, with the magnetizing current portion of the AC current modified to provide a repellant force to the rotor, so as to align the rotor. In a further embodiment, all of the windings produce current both for torque and rotor position control, providing therefore a simultaneous push-pull rotor re-orientation, by both sets of windings of that phase.

In operation, the method of the present invention is now described with reference to FIG. 2b. Information provided by sensor 160 signals that the rotor is out of alignment in the direction away from the arrow 200. In order to align the rotor correctly, the magnitude of the magnetizing current component of the waveform applied to inverter output a is adjusted. The rotor moves in the direction perpendicular to the straight line joining the two stator slots 111 and 114 containing winding 123, fed by inverter output a. Alternatively, and referring to FIG. 2c, a decrease in magnetizing current can be applied to the calculation for the waveform current of inverter output A. This would be applied to winding 121 and have an effect on the rotor, generally causing a reduction in magnetic attraction with the rotor, in the direction perpendicular to the straight line between the windings filling stator slots 105 and 108, as depicted by arrow 210. A combination of these two methods is preferred, and a simultaneous increase in magnetization current is applied to winding 123 and decrease to winding 121.

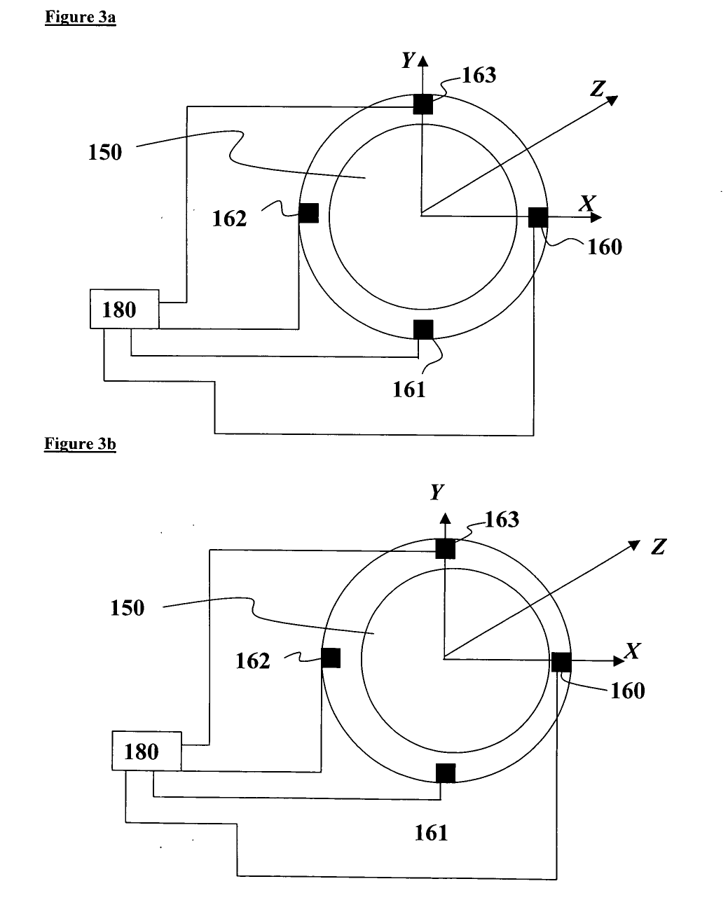

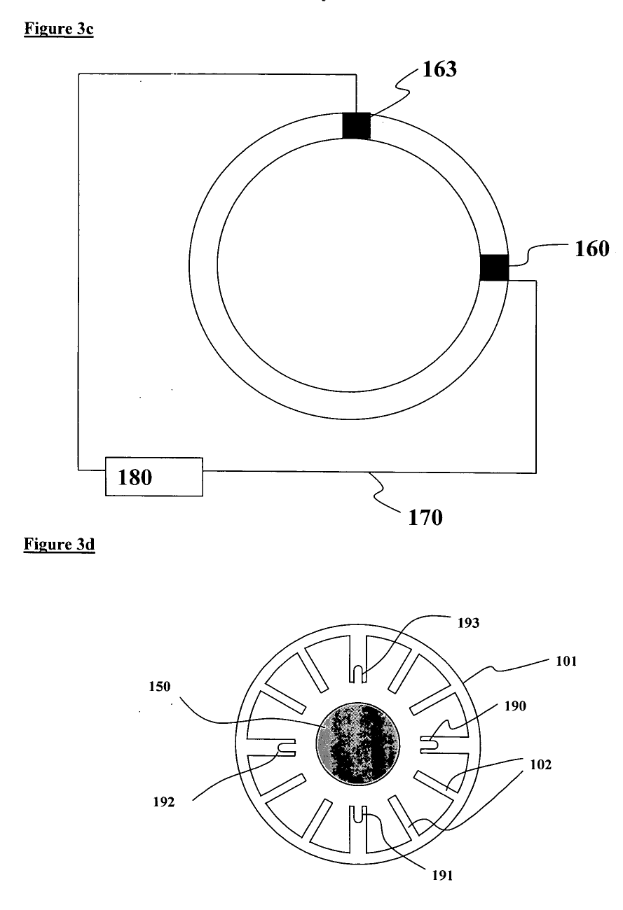

According to an alternative embodiment, a pair of sensors is provided for each orthogonal direction, and the differential used as the measurement. Thus, referring to FIG. 3a, four rotor position sensors 160 and 162, 161 and 163 are utilized to detect changes in the rotor position in two orthogonal directions, X and Y respectively. Here, the rotor is in a centrally aligned position, and rotor position sensors 160-163, would each be measuring a zero displacement. Referring now to FIG. 3b, the rotor has shifted undesirably in the +X direction. Position detector 160 should register this displacement in the +X direction, as should position detector 162. However, position detector 163 will simultaneously measure a displacement in the −Y direction, whilst position detector 161 will measure a displacement in the +Y direction. The processor will have to analyze this result. In one embodiment, the processor uses half of the sum of the outputs of each pair of sensors. Half of the sum of the outputs of 163 and 161 is zero, showing that the rotor has not moved at all in the Y direction, although both sensor elements 163 and 161 individually have sensed that a displacement has occurred. Half of the sum of the outputs of 160 and 162 will give an accurate representation of the displacement of the rotor. It is noteworthy to mention that a displacement of the rotor in the X direction will usually also cause a displacement error signal in the Y direction, for a main reason being that the rotor is round, so even if it is displaced solely in the X direction, there will be a greater distance from the rotor's displaced periphery in the Y direction than when correctly aligned.

According to a related embodiment, shown in FIG. 3c, only two sensors 160 and 163 are provided, one in each orthogonal direction. The sensors measure displacement of the rotor in an arbitrary X and a Y direction, perpendicular to one another, according to a stator X-Y plane. A signal from the sensors 160 and 163 is sent along signal lines 170 to a processor, 180 to determine which one or many of the windings should have their magnetizing current component to their waveform adjusted, to correctly align the rotor. For the purposes of simplicity, sensors are described herein as being 90 rotational degrees apart from one another, but standard vector rules allow them to be positioned at other angles, for example, if separated by 60 rotational degrees. Other configurations are also possible.

According to a further embodiment, as shown in FIG. 3d, the rotor position sensors are contained within customized stator teeth 190 and 191, 192 and 193, so that the sensors may electrically measure the rotor position, such as by measuring magnetic flux, capacitance or current flows, without interference from the stator windings. The customized stator teeth 190 and 191, 192 and 193 may be simply cutouts in the laminations, and may not be necessary, depending on the type of sensor used.

Processor 180 provides drive information to the inverter. Typically, the information is based on upon mathematical calculations such as Field Oriented Control, combining a required Torque Producing Current (i_{d}) with a required Quadrature Current (i_{q}). Field Oriented Control is a preferred control method, but other equally suitable methods known in the art for controlling the waveform current may be used, for example and without limiting the scope of the present invention, Classical Direct Torque Control. Using Field Oriented Control (FOC), the static X-Y stator frame is transformed into a rotational equivalent in the rotor's d-q frame. The quadrature current component of the rotating d-q frame serves to induce current in the rotor, which produces for the rotor a magnetic field. This rotor magnetic field rotates together with the sinusoidal cycling of the waveform current in the stator. At the same time, the stator waveform current also includes a direct current component. This is usually 90 electrical degrees away from the quadrature current component, and serves to provide a magnetic field to intersect the magnetic field of the rotor. The effect of these two components of the current in the stator windings is the interaction of the two magnetic fields, which causes movement of the rotor. A plurality of phases is usually set up in the stator, to enable the magnetic field of the rotor to be continuously intersected and maintain the steady rotation of the rotor.

In order to control the rotor's position within the stator, each phase needs to be offset in amplitude, not time, from the value predicted for it by the field oriented control algorithms. This means that after the current measurement on each phase, its offset value is subtracted from the measurement prior to running the FOC algorithms. The offset value is added back and the output sent to the amplifier stage, and thence to the motor.

In the present invention, rotor position is corrected by adjusting the magnetizing current component of the AC waveform current to the stator windings. As mentioned, using FOC, current for the windings is first calculated using the rotor's d-q frame, and then transformed for application to the windings in the stationary X-Y frame of the stator. In the present invention, it is recognized that slightly altering the magnetizing current component after the d-q frame has been transformed, of the waveform applied to any one winding will serve to increase the strength of the magnetic force applied by that winding, to the rotor, with the effect of subtly moving the rotor closer to, or further away from that winding. The principle may be applied to various windings at the same time, serving to position the rotor appropriately within the stator X-Y frame.

In this embodiment, the extra magnetizing current, causing magnetic attraction of the rotor according to the required correction factor, is added to a d-q frame, and stator currents are then calculated. It will be noted, however, that instead of having one standard d-q frame, from which all the stator winding currents are calculated, in this embodiment there are different d-q frames for the individual windings involved in the correction. The AC current for each stator winding will then be calculated according to that frame.

The effect of individual windings upon the rotor is determined according to the X and Y components of both sides of that winding within the X-Y stator frame.

The correction required is ideally updated in real time, according to any ongoing change in rotor position. The magnetizing current component through the windings will likely affect many windings at once, and throughout operation. The need for and methods for damping or removing high frequency components of the signals are well known to the art.

If complementary phases are used (eg a 6 phase machine set up as 180 degree opposed dual 3 phase machine), the FOC is performed on complementary pairs of phases; by running both phase lines through the current sensors, and doing all of the FOC algorithms. The total current going through the pairs of phases would remain correct for FOC, but after the FOC algorithm rotor positioning algorithms would be applied to set up the difference between the complementary halves. The rotor positioning algorithms could be applied before or after or as a part of the FOC.

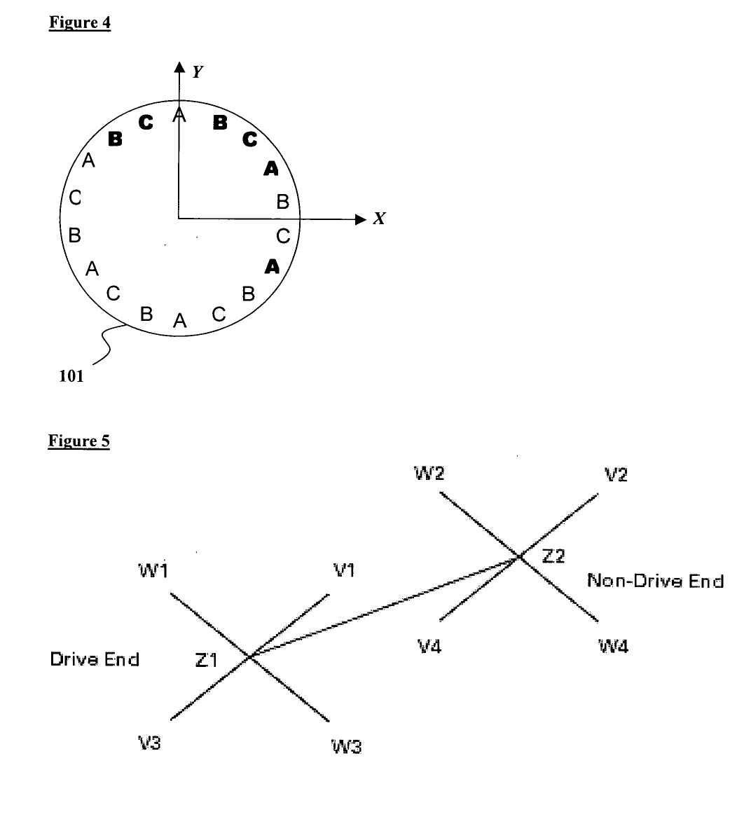

In a further embodiment, input AC current is modified for only two or three of the windings in order to re-position the rotor, whilst the other windings have AC current whose magnetizing current portion is independent of rotor position. Referring now to FIG. 4, the stator portion of a three phase six pole motor is shown, with windings of each of the three phases being labeled as A, B and C, respectively. Sensors (not shown), measure the displacement from a radially aligned position, of the rotor (not shown) in terms of X and Y. The phases A that are marked with a bold A are connected together with a single winding and used to control the displacement of the rotor in the X direction since the Y component of the two sides of the winding cancel one another out. The phases B that are marked with a bold B are connected with one winding, and the phases C that are marked in bold are connected with one winding; these two phases are used in combination to control the Y component of the rotor orientation. It will be noted that between windings B and C, any X component will be cancelled out, since they center around the Y axis. Orientation of the rotor in the direction of the Y axis will be divided evenly between the two phases B and C. In a similar embodiment, phases need not center around an axis they are controlling, and instead standard vector rules can allow any two different phases to control the rotor in any direction. Additionally, it is not necessary that the rotor is controlled in orthogonal directions, and it can be held in alignment with control in two other directions, such as at 60 rotational degree difference. In this embodiment the other phases only provide the usual AC waveform current for journaling the rotor. The benefits of this embodiment are that when a large number of phases or poles are used, such as 7, 18, or even 60 phases, all of the phases not used for rotor positioning may be connected together in a mesh to inverter outputs, instead of each winding requiring its own pair of dedicated inverter outputs. Therefore, the embodiment that uses only certain phases to control rotor position reduces the number of inverter output legs required.

In another embodiment, all of the windings of the motor are used to control rotor position, as well as for their normal usage, of providing torque to the rotor. In order to control rotor position, as mentioned above, the magnetizing current portion of the electrical current fed to the windings must be controlled according to a continuing sensor output string.

In a further embodiment, an additional magnetic thrust bearing will be needed. In many of the embodiments described above and below, the magnetic reluctance will tend to draw the rotor into the center of the stator, but in this embodiment, an additional magnetic thrust bearing is used. The direction of this bearing is shown with lines z1-z2, in FIG. 5.

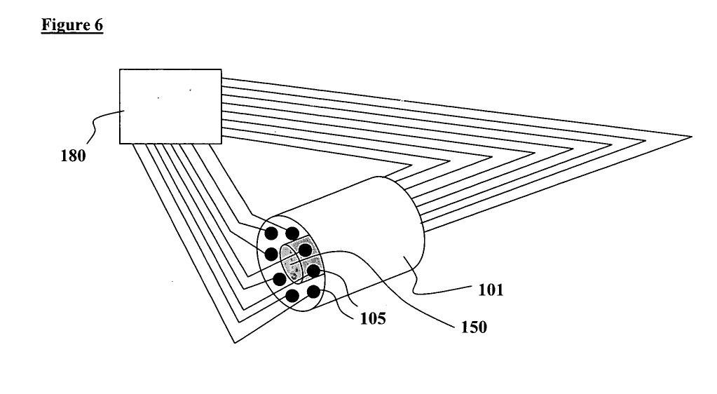

With reference to FIG. 6, eight stator conductors run down the length of the stator, and are connected at both ends to a processor 180, which includes an inverter. Sensors at either end of the stator determine mal-positioning of the rotor 150 in an X and a Y radial direction. The inverter outputs at each end of the conductors produce a voltage difference and a current flowing through that conductor. Therefore a correction factor may be applied to each conductor alone, to cause an increase or decrease in magnetization current towards that particular conductor. A similar embodiment consists of a toroidal motor. In this embodiment involving conductors on one side of the stator unconnected to those on the other side of the stator, the stator may be set up with only two, or if desired, more, magnetic poles.

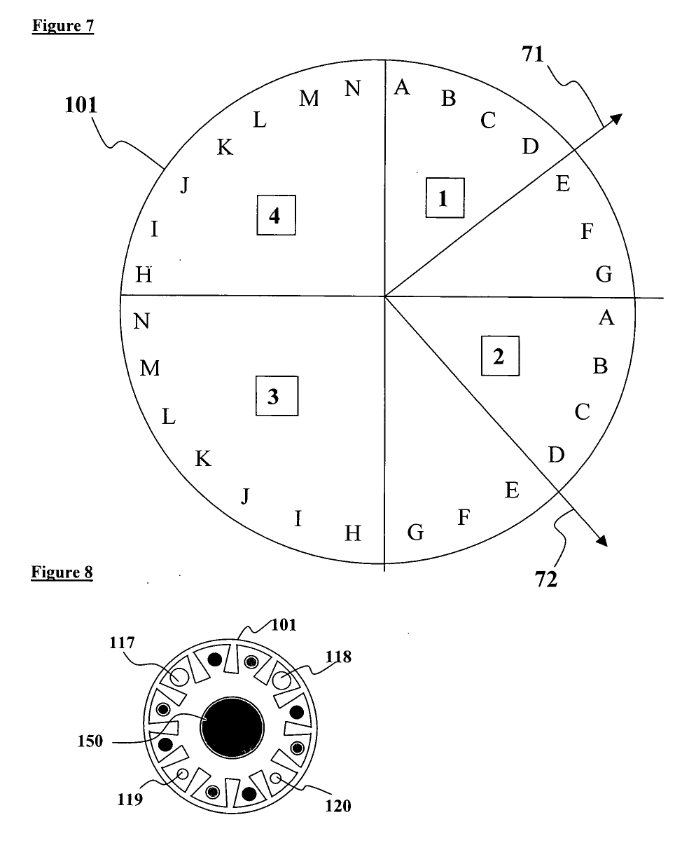

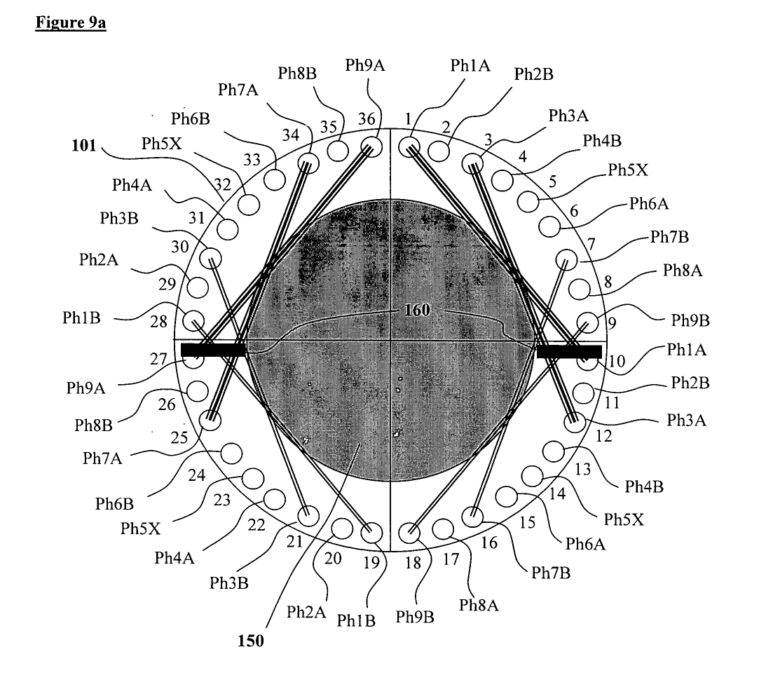

In a further embodiment, the application of this approach to polyphase motors is contemplated. As described in my previous inventions (U.S. Pat. Nos. 6,054,837; 6,570,361; 6,351,095 and 6,348,775), stators with many different phases can deal more effectively with temporal harmonics, as the harmonics below the phase count are not aliased to become spatial harmonics. As a result inverters with lower grade output can be successfully used without substantial effect on the rotor rotation smoothness. In the present invention either all or some of the phases may be used to control the rotor alignment. In a many-phased machine, it may be economical to use the minimum number of phases to control rotor position, which is usually three, as described below. In this way, phases that are not involved in the control of the rotor position do not need, for each pole, to be fed by a separate inverter half-bridge, but instead, may have a common half-bridge inverter output feeding the same phase in each of the poles. This reduces the number of half-bridges needed. In a preferred embodiment, one phase is selected as a base phase. Two adjacent poles of this phase are connected together, to provide control from a first direction, and the other two poles in a four pole machine, are connected together to provide control from the opposite direction. Then a pair of phases, to provide control in a direction 90 physical degrees away from the first direction, is chosen. The two phases must be chosen so that when these two phases are each wound with a single winding to the same phase in the adjacent pole, the sum of the angular difference between each pair of joined phases should equal 90 degrees from the base phase. For example, when using a four pole seven phase motor, the motor may be divided up into four quadrants, 1, 2, 3 and 4, as shown in FIG. 7. Phases marked A from quadrants 1 and 2 are joined together with one winding, as are the two phases marked B, etc. Phase A of quadrant 1 is chosen as the base phase, and will have an effect directly in the direction of the arrow 71. The pair of phases that may be chosen to provide control in a perpendicular direction to phase A, that is, in the direction of the arrow 72, will be either B and G, or C and F, or D and E, from the right hand side of the stator, or the equivalent from the left hand side of the stator, namely L and K, or M and J, or N and I. Whatever the choice, let us choose D and E, for example, each of these windings A, D and E will be connected to a dedicated inverter terminal, and their opposites, H, K and L, on the other side of the stator, will also need to be connected to dedicated inverter terminals, and therefore may as well be equally involved in rotor positioning. However, the rest of the phases, B, C, F and G, and I, J, M and N, do not each require a dedicated inverter terminal, and B may be connected together with I to the same inverter terminal, C with J, F with M and G with N. All of the phases are provided with AC drive, while the three chosen phases, such as for example, A, D and E, will be provided with modified magnetizing current content to control the rotor position. In addition, phases H, K and L may also be provided with the modified magnetizing current content current, to provide simultaneous push-pull effects on the rotor.

In a related embodiment, three phase windings are chosen, each to provide rotor positioning effects, while the remaining phase windings are simply used to provide the regular current for production of magnetic flux and torque.

In a further related embodiment, a six pole motor is used, with any number of phases. Being that there are six poles, there are three windings for each phase. According to this embodiment of present invention these three windings of any one phase would each be separately driven by dedicated inverter phases to control the rotor position. Particularly in a concentrated winding machine, the three windings of any one particular phase would be equally spaced around the stator, and would be well suited to being used as the windings that position the rotor.

In a multiphase motor, such as a seven phase motor, or with even a much higher phase count, temporal harmonics below the phase count may be added, without becoming spatial harmonics. For example, in a six or seven phase motor, third and fifth harmonic may be added to produce extra torque synchronized in speed and direction with the fundamental torque. In order to control the rotor position, according to the method of the present invention, harmonics, such as third and fifth harmonic in a six or seven phase machine, may be added to the waveform. According to this embodiment, the magnetizing current component of the fundamental AC waveform is not modified to control the rotor position. Instead, the magnetizing current component of the extra, injected harmonics, is modified to control rotor position. Similar to the first embodiment mentioned above, in order for this embodiment to be effective, windings cannot span 180 physical degrees on the stator, therefore the machine should be wound with a four pole or higher pole count configuration. Each phase of each pole is connected with one winding to the equivalent phase in the adjacent pole, and each winding is connected to its own inverter output. Third harmonic (and/or other harmonics) are synthesized with a magnetizing current component sized according to the required correction factor. In a further embodiment, a harmonic, for example, the third harmonic may be synthesized purely with a magnetizing current component equivalent only to that required for correction of rotor position and with no direct current component at all. Using the third or other harmonic in this way may be a good way to separate out the rotor positioning algorithm from the FOC algorithm. Again, some or all of the phase windings can be used for rotor positioning, in a preferred embodiment, all of the phase windings also include rotor positioning ability, whereas in another embodiment, only some of the windings are used with this extra capability.

In a further embodiment, a motor having four or more poles is proposed, in which the motor is designed to be operated horizontally, that is, the rotor 150 rotates around an axis parallel to the ground. The stator slots are arranged so that there are two stator slots for the same electrical phase located vertically higher than the rotor and equidistant in a horizontal direction from the rotor. While this embodiment can be used in conjunction with the first embodiment, described above, this second embodiment does not require the use of rotor position detectors. Referring now to FIG. 8, which shows a cross-sectional view of the stator, in which the top of the page is to be viewed as pointing up towards the sky, stator slots 117 and 118 are located physically above the rotor, each slightly above and to one side of the rotor. A single winding (not shown), connects between them, and another winding connects between the other two stator slots of the same phase, which are also shown as white stator slots, 119 and 120. Each single winding is composed of a long wire fed all the way along the length of the stator through a first stator slot (such as 117, or 119), round the stator end, and then back along the stator through a second stator slot (such as 118, or 120), turning at the end of the stator, and going through the first stator slot again. The windings are very long and for example, may include fifty turns. In one embodiment of the present invention, all the other stator slots are filled with windings having n turns, whilst the winding filling stator slots 117 and 118 has n+1 turns. It is anticipated that for symmetry purposes, it may also be desirable that the winding filling stator slots 119 and 120 should have n-1 turns. Therefore, for example, if most of the windings have 50 turns, then the winding filling stator slots 117 and 118 should have for example 51 turns, and the windings filling stator slots 119 and 120 should have 49 turns. For a greater effect, the windings filling stator slots 117 and 118 may have many more turns than those filling stator slots 119 and 120. The benefit of this is that gravitational forces pulling the rotor slightly downwards along the whole length of the rotor, are compensated for by the slight additional attractive force in the upwards direction by the effect of the greater number of turns in the winding filling stator slots 117 and 118. This may be seen by the formula which shows that the magnetic attraction between the rotor and stator is related to the number of turns in the stator windings. The two stator slots 117 and 118 individually have an additional angular component, causing the rotor to be pulled to the left and to the right, however, in combination, these two forces are equal and opposite and act to cancel each other out and do no work. The closer the two slots 117 and 118 are to one another, the less current will be wasted by counterbalancing forces. Therefore, when a motor is disposed horizontally with regard to a central axis around which a rotor rotates, and the stator windings are wound with a four or greater pole configuration, then the stator windings above the central axis, should, on average, have a greater number of turns than the stator windings that are disposed lower, in a vertical direction, than said central axis. This embodiment can also be used to align the rotor relative to any known constant force, eg, if it is being used in a pulley system.

In a further embodiment, the windings above the rotor do not have extra turns but they are provided current having a modified magnetizing current component to act against gravitational effects. The modified magnetizing current component of the current waveform may be pre-calculated, or subject to look-up tables, or the result of sensor output, etc. If it is pre-calculated, it should take into account the rotor weight and additional forces caused by the environment and the load.

In some embodiments, stator windings, and thus electrical phase angle, are not necessarily evenly distributed. In other embodiments, an increase in stator windings in two poles of one phase, is compensated by a decrease in stator windings in the other two poles of the same phase, so that the total phase current amplitude of that phase is equal to the phase current amplitudes of the other phases.

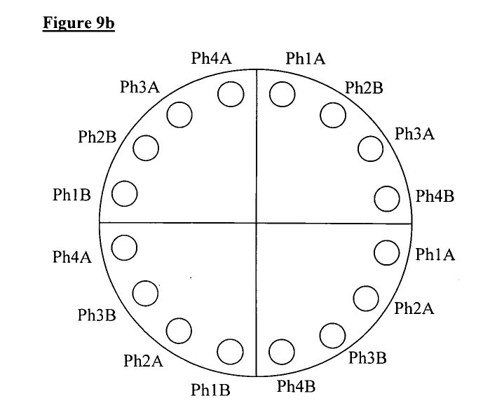

With reference now to FIG. 9a, a further embodiment is shown in which each phase does not require a separate drive for each winding. The stator slots are numbered 1-36, and the phases are labeled Ph1 to Ph9. In addition, the phase windings that have additional turns are labeled with an A, such as Ph1A, and the phase windings that have reduced turn counts are labeled are labeled with a B, eg Ph1B. Every second phase has an extra turn on alternate opposite sides of the stator. When it is desired to move the rotor to one side of the stator or the other, either the odd phases or the even phases are slightly energized over the other. The effect will be felt greater on the side of the stator that has increased winding turns, and therefore the rotor may be positioned accurately.

In FIG. 9b, the equivalent is shown with a four phase stator in which Phases 1 and 4 control the rotor in the X direction and phases 2 and 3 control the rotor in the Y direction. The turn count is more or less balanced around the stator, and the inverter may be used to accentuate any one or combination of phases to align the rotor. The specific example is provided for exemplary purposes only and, due to the low number of phases, might not have a terribly well balanced rotor, when no rotor alignment control is being applied. The extra turns produce a bias, and in normal running operation, the bias of the added turns should be spread out around the rotor. If there were more phases for each direction of added turns, as in FIG. 15a, the number of added turns would be better balanced around the rotor, and would not negatively affect the rotor under normal operation. When one wants to align the rotor to one direction or another, the phases with the added turns are given extra (or reduced) current so that they have more of an effect on the rotor, in the direction they are biased towards. The figure is shown with added windings in four directions, so that the rotor can be affected in both the X and Y direction, and yet when no rotor control is being applied, the drive is balanced. However, the added windings could instead for example be in three directions 120 degrees apart. This also allows fully balanced normal drive, yet the can still be aligned. The processor can add current to the waveform for that phase, eg, provide it with 110% of the current of the other phases, in order to attract or repel the rotor. The processor can apply control to more than one phase at the same time.

While this invention has been described with reference to numerous embodiments, these are not to be construed as limiting the scope of the invention. For example, the processor 180, may have the additional capability of determining the effect that various windings have on the rotor displacement, and may be able to use only one winding to correct rotor displacement, or a combination of windings. Furthermore, the individual inverter outputs may be connected each to individual processors, for the calculation of their waveform current, instead of there being one centralized processor. In the course of this specification, the processor has been used as a generic term, and may contain the FOC and inverter, or these may be separate units. These features are known in the art and while the processing and algorithms are new according to the present invention, the units themselves are known in the art, and the means are related to those used for active magnetic bearings.

The present invention may be used in combination with passive bearings, such as ball-bearings. Slight changes in rotor position could be accurately measured by the rotor position detectors, and compensated for by altering the magnetizing current component applied to one or more windings, to re-align the rotor. In this way, bearing wear and tear is minimized. The use of passive bearings can greatly enhance the usage of the present invention. Also, magnetic bearings may be used in combination with the present invention. Alternatively, the method of the present invention could be used in place of passive bearings, serving to completely align the motor.

Other modifications are considered within the scope of the present invention. In a further embodiment, there may be more sensors (or other rotor position detectors), with more complex responses. One embodiment uses more than two rotor position sensor elements within one X-Y plane, and the combination of signal outputs is computed by the processor to produce a composite mapping describing rotor position relative to a desired position, from which mapping, appropriate magnetizing current and other currents are calculated for each inverter output individually. Sensors may instead be located inside a hollow in the rotor core, or between the rotor bearings and the housing. Sensors are not limited to any particular type, and may take the form of any sensor or measurement technique that can determine, for example, the rotor misalignment or detect movement of the rotor from an aligned position, or determine the proximity of the rotor to the end bells. Sensors may use optical interferometry, ultrasonic, radio frequency (RF) or be pressure sensitive. They may also alternatively measure the wear or the pressure on the bearings. Additionally sensors may be placed at both ends of the stator so that the processor may determine whether a mal-positioned rotor has simply moved to one side along the whole of its length, or only at one end. If the rotor is tending towards a wrong position along the whole of its length, this may be corrected by the varying the magnetizing current of the stator conductors according to the present invention. However, if the rotor is tending to a wrong position only at one end, it would be inappropriate for the processor to apply magnetizing current to the stator coils, for they would act to move the rotor towards the opposite direction, along the whole of the rotor length, resulting in correction where none had been needed. Sensors are arranged to measure two orthogonal directions at one end of the stator, while further sensors are arranged against the same two orthogonal directions, at the other end of the stator. The output signals from the sensors are sent to the processor and used to calculate any errors in rotor positioning.

In a further embodiment, the stator windings provide control over the rotor's positioning while active magnetic bearings separately feature at one or both ends of the stator to further help in the rotor positioning, and to compensate for tilting, twisting and drag of the rotor.

In a further embodiment, there may be many more slots, such as thirty, and a single phase in a single pole may cover more than one stator slot. However for the sake of clarity, these have been reduced to a single stator slot in FIG. 2a. Additionally, the shape of stator teeth may vary widely from the way they are displayed in the Figures.

In the foregoing, for a four pole motor, four stator slots are all filled with windings of essentially the same phase; nevertheless, since the magnetizing current component of the current to one of the windings is modified in order to reorient the motor, this will cause the AC waveform current in the one winding to be slightly out of phase with the AC waveform current of the other winding. Similarly, in a three phase, six pole motor, although the three phases may be arranged physically on the stator with equal physical angle difference between each phase and the next, nevertheless the current will not be exactly in phase—with the differences being suited to positioning the rotor correctly while maintaining drive balance.

The stator is shown as having three phases, and four poles, however, the number of different phases may be increased (or there may even be just two different phases) and there may be six or more poles. In addition, with short pitch windings, only two poles may be used. A motor has been described as having four or six poles, but it could equally contain more or fewer poles.

In a further embodiment, incorporating a high phase order motor or generator, the standard magnetic bearing coils might be added to the main body of the stator. The magnetic bearing coils would be a high frequency (high pole count) winding, superimposed on then main traction winding. This supplementary winding would have a problem of having “end turns in the center” of the rotor, but it would be a small winding, with very little in the way or end turns, so very little iron would be lost.

The industry standard induction machine is the squirrel cage induction motor. In this motor, the region of interaction between the stator and the rotor may be considered the surface of a cylinder. Rotation is about the axis of the cylinder, lines of magnetic flux pass through the cylinder normal to the cylinder, and current flow in both the stator conductors and the rotor conductors is parallel to the axis of the cylinder.

The present invention is applicable to any geometry in which the region of interaction between stator and rotor has circular symmetry about the axis of rotation, magnetic flux is generally normal to the region of interaction, and current flow is generally perpendicular both to flux and the direction of motion.

The present invention is applicable to all geometries of the AC induction machine. It is further applicable to both squirrel cage and wound rotor machines. The present invention is also applicable to many different inverter topologies used for the operation of three phase machines. These include voltage mode pulse width modulation inverters, which provide an alternating current regulated to a specified RMS voltage, current mode pulse width modulation inverters, etc.

While this invention has been described with reference to numerous embodiments, it is to be understood that this description is not intended to be construed in a limiting sense. Various modifications and combinations of the illustrative embodiments will be apparent to persons skilled in the art upon reference to this description. It is to be further understood, therefore, that changes or modifications in the details of the embodiments of the present invention and additional embodiments of the present invention will be apparent to, and may be made by, persons of ordinary skill in the art having reference to this description. It is contemplated that all such changes and additional embodiments are within the spirit and true scope of the invention as claimed below.

### INDUSTRIAL APPLICABILITY

The present invention describes an approach for reducing bearing wear in electric motors.

1. A motor having an actively alignable rotor comprising
a) a rotor; and
b) a stator, comprising a plurality of conductors supplied with electrical current for rotating said rotor; and wherein a conductor set comprising some or all of said conductors span less than 180 rotational degrees on the stator; and
c) a rotor position sensor for determining a rotor misalignment; and
d) a control unit for controlling the current supplied to said stator conductors; and
e) a processor connected to said control unit and to an output of said rotor position sensor, for incorporating within a magnetizing torque for each of the conductors of said conductor set a factor that substantially realigns said rotor.

2. The motor of claim 1 wherein said motor is an induction motor.

3. The motor of claim 2 wherein said control unit comprises field oriented control.

4. The motor of claim 2 wherein said motor comprises four or more poles, and wherein each phase of said conductor set comprises a plurality N of individually driven windings, where N equals half the number of stator poles, and wherein said windings are wound between adjacent poles.

5. The motor of claim 4 wherein said processor comprising means for distributing the total phase current of each phase of said conductor set amongst the individually driven windings of that phase, according to the effect of the position of each winding on the rotor, to realign the rotor.

6. The motor of claim 1 wherein said conductor set comprises a maximum of four windings to control the rotor alignment.

7-8. (canceled)

9. The motor of claim 1 wherein said position sensor comprises one or more position sensor units and each of said position sensor units is located in at least one of a set of locations consisting of: the surface of said stator facing said rotor; a tooth of said stator; the surface of said rotor; and the gap between said stator and said rotor.

10. The motor of claim 1 wherein said position sensor comprises at least two position sensor units, each of said at least two position sensor units being functional to determine the displacement of said rotor from its aligned position in a single direction, each of said single directions of a position sensor unit being perpendicular to the axis of rotation of said rotor.

11. The motor of claim 10 where at least one of said directions of a position sensor unit is perpendicular to a direction of another position sensor unit.

12. The motor of claim 1 wherein said motor also includes passive bearings.

13. The motor of claim 1 wherein said motor also includes magnetic thrust bearings.

14. The motor of claim 2 wherein said motor is driven by at least three phases, each including at least two windings;
wherein at least one winding of a first phase of said at least three phases is individually driven by a first inverter output to control rotor alignment in a first direction; and
at least one winding of a second phase of said at least three phases and at least one winding of a third phase of said at least three phases are symmetrical about a second direction perpendicular to said first direction; and
said winding of said second phase is individually driven by a second inverter output and said winding of said third phase is individually driven by a third inverter output to control rotor alignment in said second direction.

15. The motor of claim 2 wherein said motor is driven by a multiplicity of phases, each phase including at least three windings;
wherein one of said at least three windings of a first phase of said phases is individually driven by a first inverter output to control rotor alignment in a first direction, and
a second winding and a third winding of said first phase are symmetrical about a second direction perpendicular to said first direction, and
said second winding is individually driven by a second inverter output and said third winding is individually driven by a third inverter output to control rotor alignment in said second direction; and
wherein phases other than said first phase are not driven to control rotor alignment.

16. The motor of claim 15 wherein said windings each of said phases not used for rotor alignment are connected in a mesh connection to an inverter output.

17. The motor of claim 2 wherein said stator comprises at least 3 individually driven phases and wherein harmonic fields of a number less than or equal to the number of phases are added to produce extra torque synchronized in speed and direction with the magnetizing torque supplied by the fundamental AC waveform.

18. The motor of claim 17 wherein said magnetizing current of said fundamental AC waveform does not include a component driven to control rotor alignment, and the magnetizing current of said added harmonics includes a component driven to control rotor alignment.

19. An aligning motor comprises a stator and a rotor, wherein said rotor is subjected during operation to a constant force from a first direction, and wherein said stator comprises at least one coil comprising a span of less than 180 rotational degrees, and wherein an imaginary line joining the stator slots containing said at least one coil is substantially normal to said first direction and wherein said at least one coil is wound with a different number of winding turns to the number of winding turns in the other coils to provide a magnetizing torque to aid the rotor in withstanding said constant force.

20. A motor comprising a rotor and a stator comprising two or more windings for each phase, wherein windings span less than 180 stator degrees and wherein, for some or all of the phases, one of the windings has a greater turn count than another winding of the same phase, and wherein variation in turn count is substantially distributed around the stator and further comprising a sensor for sensing misalignment of said rotor, and a processor for adjusting the phase current to the phases that have a higher turn count in an angular position relative to the rotor capable of influencing the rotor into alignment.
